(19) United States
(12) Patent Application Publication
(10) Pub. No.: US 2026/0020711 A1
(43) Pub. Date: Jan. 22, 2026

(54) Autonomous Multifunctional Pressure Cooker System

(71) Applicant: Sasan Matinifar, Wilmington, CA (US)

(72) Inventor: Sasan Matinifar, Wilmington, CA (US)

(21) Appl. No.: 19/075,870

(22) Filed: Mar. 11, 2025

Related U.S. Application Data
(60) Provisional application No. 63/671,799, filed on Jul. 16, 2024.

(51) Int. Cl. A47J 27/092; A47J 27/04; A47J 43/044

(52) U.S. Cl. CPC A47J 27/092; A47J 27/04; A47J 43/044; A47J 2027/043

(57) ABSTRACT

The present invention is an advanced automated (i.e., autonomous) pressure cooker system. The system includes a pressure cooker body with a sealing lid and an integrated mixing arm driven by an electromotor. The mixing arm operates at a low speed for uniform ingredient stirring and when detached from the electromotor, the electromotor rotates at a high-speed vacuum mode, thereby venting air to preserve food. A control area network (CAN) manages the system, uses sensors to regulate pressure and temperature cooking. The pressure cooker is supported by a heater stove with an embedded weighing scale, a heating coil with ceramic insulation, and digital interfaces for customization and recipe storage. The system provides nutrient retention, cooking consistency, and safety using a vent port, a safety valve, and ergonomic clamps.

### CROSS-REFERENCE TO RELATED APPLICATION

The present application claims priority to, and the benefit of, U.S. Provisional Application No. 63/671,799 which was filed on Jul. 16, 2024 and is incorporated herein by reference in its entirety

### FIELD OF THE INVENTION

The present invention generally relates to automated (i.e., autonomous) cooking systems. More specifically, the invention relates to an advanced multifunctional pressure cooker system designed to enhance cooking efficiency, automate food preparation, and extend food preservation. The system comprises a pressure cooker integrated with a control module for monitoring and managing cooking parameters, such as pressure, temperature, and stirring speed. The system features a dual-speed electromotor that drives a mixing paddle for uniform stirring at a low speed during cooking and switches to a high-speed mode for vacuum-sealing by venting air. Additionally, the system is supported by a heater stove equipped with a weighing scale for precise ingredient measurement, a strain gauge load cell, and a ceramic insulator for heat protection. Accordingly, the present disclosure makes specific reference thereto. Nonetheless, it is to be appreciated that aspects of the present invention are also equally applicable to other like applications, devices, and methods of manufacture.

### BACKGROUND

By way of background, cooking is a fundamental daily activity, and individuals want devices and methods to prepare meals that are both healthy and convenient. Among various cooking devices, pressure cookers are commonly used as they reduce cooking time and preserve nutrients in food. The high-pressure environment inside a pressure cooker enables food to cook faster, using less water and energy compared to traditional methods, which also helps retain essential vitamins and minerals.

However, conventional pressure cookers lack the versatility, such as precision in cooking, automated (i.e., autonomous) control, and extended food preservation. For example, food oxidation is caused by the presence of oxygen during or after cooking and can degrade the quality and nutritional value of meals. Although vacuum-sealing technologies exist to mitigate oxidation, integrating this feature into a pressure cooker remains a challenge. Traditional methods of creating a vacuum often require separate equipment, leading to inefficiencies, higher costs, and additional manual effort.

Another limitation of conventional pressure cookers is their inability to uniformly mix ingredients during the cooking process. Without stirring, food can overcook or stick to the sides, compromising texture and taste. Similarly, traditional systems lack dynamic control mechanisms for pressure, temperature, and ingredient consistency, requiring users to frequently monitor and adjust the cooking process manually. Accordingly, individuals desire an improved and automated (i.e., autonomous) pressure cooker system that can overcome shortcomings of conventional cookers.

Therefore, there exists a long-felt need in the art for a multifunctional kitchen system that combines cooking, mixing, and food preservation in a single device. There is a long-felt need for a system that can automate the cooking process and reduce the need for manual intervention. Additionally, there is a long-felt need for a pressure cooker system that can minimize nutrient loss and prevent food oxidation. Furthermore, there is a long-felt need for a device that can provide precise control over cooking parameters such as pressure, temperature, and ingredient viscosity. More specifically, there exists a long-felt need in the art for an improved pressure cooker device that does not require food to be refrigerated after cooking. Finally, there exists a long-felt need in the art for a system that is safe, energy-efficient, and equipped with advanced digital features to meet the demands of modern households and professional kitchens.

The subject matter disclosed and claimed herein, in one embodiment, comprises an advanced automated (i.e., autonomous) pressure cooker system. The system includes a pressure cooker drum with a sealing lid that provides controlled internal pressure and minimizes steam loss during cooking. The lid includes integrated sensors for monitoring atmospheric and internal pressure, a vent port controlled by an actuator, and a safety valve compliant with SAE standards. The system further includes an electromotor coupled to a mixing arm and rotor shaft for slow speed stirring for uniform cooking and high-speed operation for vacuum sealing by venting air from the vessel. A heater stove supports the pressure cooker and includes an embedded weighing scale for accurate ingredient measurement, a strain gauge load cell for precision, and a ceramic insulator for heat protection.

In this manner, the automated (i.e., autonomous) pressure cooker system of the present invention accomplishes all of the foregoing objectives and provides a practical and user-friendly pressure cooker device for modern cooking needs. The system simplifies the cooking process and automates key steps such as stirring, pressure adjustment, and temperature control. The vacuum-sealing prevents oxidation and extends the freshness of meals. The integrated weighing scale and digital interface enhance the accuracy and convenience of ingredient measurement and cooking customization. The display screen, USB, and memory card ports enable for recipe customization and easy customization of settings to meet various cooking requirements. The rotor shaft with spiral vanes provides even mixing, preventing food from sticking or overcooking.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises an automated (i.e., autonomous) pressure cooker system. The system comprises a pressure cooker body configured to prepare liquid-based meals and maintain a controlled internal pressure. An electromotor is operatively coupled to a mixing arm, the mixing arm is configured to rotate at a first speed of approximately one rotation every 2-6 seconds (i.e., from 10 to 30 revolutions per minute (RPM)) for stirring ingredients and at a second speed of at least 700 RPM upon removal of the mixing arm to create a vacuum by venting air from the pressure cooker body. A lid seals the pressure cooker body, the lid comprising a vent port and a safety valve to regulate internal pressure. A control area network (CAN) is integrated with sensors disposed in the lid, the sensors are configured to measure atmospheric and internal pressure, and the CAN controls the actuator based on the pressure measurements.

In another aspect, a heater stove is included and has an integrated weighing scale for measuring ingredients, the stove further comprises a heating coil for applying heat to the pressure cooker body, a ceramic insulator to protect the weighing scale, and a display screen for monitoring system parameters.

In another embodiment, a pressure cooker system is disclosed. The pressure cooker system includes a pressure cooker drum with a sealing lid, the lid includes a vent port controlled by a spindle shaft and an integrated safety valve compliant with SAE standards. An electromotor is mounted above the pressure cooker drum and is operatively coupled to a rotor shaft, the rotor shaft has a screw union connector for attaching and detaching a mixing arm, the electromotor is configured to operate at a slow stirring speed and a high-speed vacuum mode. A heater stove supports the pressure cooker drum, the stove comprises a strain gauge load cell coil, a ceramic insulator protects the weighing scale, and a plurality of springs are disposed in a spring housing for structural flexibility. The control area network (CAN) includes sensors for measuring internal pressure and atmospheric conditions. The CAN is configured to control the spindle shaft and heater coil. A USB port and memory card slot are included for saving and retrieving cooking parameters and recipes.

In one embodiment, an advanced cooking system is disclosed. The system comprises a pressure cooker vessel sealed by a lid, the lid includes ergonomic handles for placement and removal, a vent port, a safety valve to maintain pressure within safe limits, and sensors configured to monitor internal pressure. A mixing arm is operatively coupled to a rotor shaft, the rotor shaft includes spiral vanes for mixing, the mixing arm is detachable to enable the system to transition from stirring to vacuum sealing. A heater stove is integrated with a digital display, temperature control knob, and weighing scale and heater stove further includes a strain gauge load cell for precise weight measurement, a heating coil insulated by a ceramic layer, and supporting legs for stability during operation.

In another aspect, the system is configured to dynamically adjust cooking parameters based on inputs from sensors and stored settings in a memory card or USB device.

In still another embodiment, the automated (i.e., autonomous) pressure cooker system combines multiple functions in one device, enabling users to prepare, mix, cook, and preserve food using a single unit. The vacuum-scaling feature removes oxygen, reducing oxidation and extending food freshness. The system dynamically adjusts pressure, temperature, and stirring based on real-time sensor data, reducing the need for manual intervention. The vent port and the safety valve provide optimal pressure release without excessive nutrient loss.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of automated (i.e., autonomous) pressure cooker system of the present invention in accordance with the disclosed architecture;

FIG. 2 illustrates a top view of pressure cooker lid in accordance with one embodiment of the present invention;

FIG. 3 illustrates a planar view of one embodiment of the heater stove used in the system of the present invention in accordance with the disclosed structure; and

FIG. 4 illustrates a planar view of the automated (i.e., autonomous) pressure cooker system of the present invention in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a multifunctional kitchen system that combines cooking, mixing, and food preservation in a single device. There is a long-felt need for a system that can automate the cooking process and reduce the need for manual intervention. Additionally, there is a long-felt need for a pressure cooker system that can minimize nutrient loss and prevent food oxidation. Furthermore, there is a long-felt need for a device that can provide precise control over cooking parameters such as pressure, temperature, and ingredient viscosity. More specifically, there exists a long-felt need in the art for an improved pressure cooker device that does not require food to be refrigerated after cooking. Finally, there exists a long-felt need in the art for a system that is safe, energy-efficient, and equipped with advanced digital features to meet the demands of modern households and professional kitchens.

The present invention, in one exemplary embodiment, is an advanced cooking system. The system comprises a pressure cooker vessel sealed by a lid. The lid includes ergonomic handles for placement and removal, a vent port, a safety valve to maintain pressure within safe limits, and sensors configured to monitor internal pressure. A mixing arm is operatively coupled to a rotor shaft, the rotor shaft includes spiral vanes for mixing, the mixing arm is detachable to enable the system to transition from stirring to vacuum sealing. A heater stove is integrated with a digital display, temperature control knob, and weighing scale and heater stove further includes a strain gauge load cell for precise weight measurement, a heating coil insulated by a ceramic layer, and supporting legs for stability during operation.

Reference will now be made in detail to the present preferred embodiments of the invention, examples of which are illustrated in the accompanying drawings. Wherever possible, the same reference numerals are used in the drawings and the description to refer to the same or like parts.

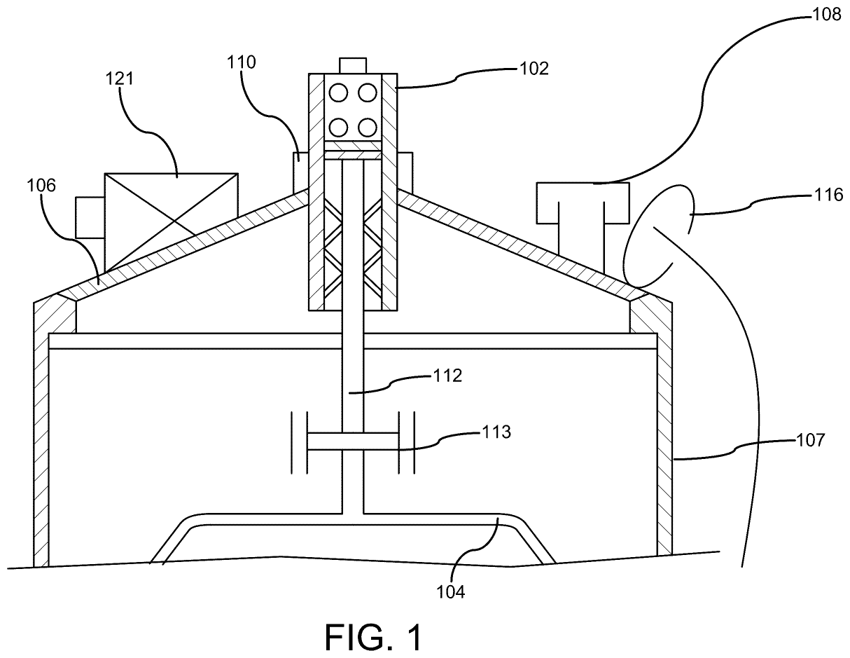

Referring initially to the drawings, FIG. 1 illustrates a perspective view of one potential embodiment of automated (i.e., autonomous) pressure cooker system of the present invention in accordance with the disclosed architecture. The automated (i.e., autonomous) pressure cooker system 100 of the present invention is designed as an advanced multifunctional kitchen device that combines cooking, stirring, vacuum-sealing, and food preservation functionalities in a single unit. The pressure cooker system 100 is specifically designed to prepare liquid-based meals such as soups or stews and provides convenience, efficiency, and consistency in the food making process. The pressure cooker system 100 includes an electromotor 102 which powers a mixing arm 104. The mixing arm 104 is designed to operate at a slow speed of one rotation every 2-6 seconds (i.e., 10 to 30 RPM) to gently mix ingredients and prevent overcooking on any side. Also, when the arm 104 is removed, the electromotor 102 increases the speed of the rotor shaft to at least 700 RPM. The high-speed extracts air from the pressure cooker system 100, creating a vacuum to reduce oxygen levels, preventing oxidation, and preserving food longer.

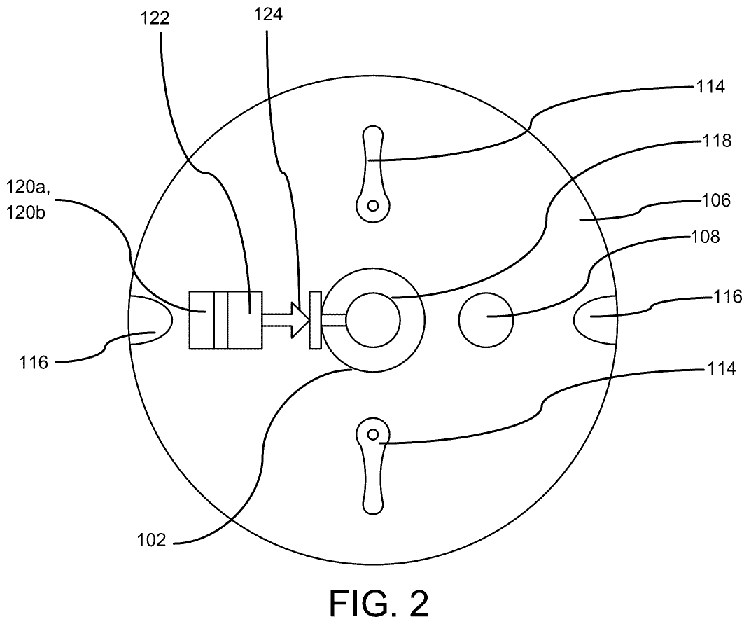

A pressure cooker lid 106 is included for sealing the pressure cooker body or drum 107 to maintain a controlled pressure inside the system 100. A safety valve 108 enables the pressure inside the pressure cooker to be within safe limits and is compliant with SAE standards. A vent port 110 enables controlled release of steam and opening and closing of the vent port 110 may be managed and controlled by a spindle shaft (shown in FIG. 2).

A rotor shaft 112 is coupled to the mixing arm 104 for uniform stirring of ingredients during cooking. The electromotor 102 drives the rotor shaft 112 and enables the mixing arm 104 to operate at the low speed. The rotor shaft 112 includes a plurality of spiral vanes for effective mixing of ingredients and features a screw union connector 113 for easy attachment and detachment of the mixing arm 104. The vacuum sealing inside the pressure cooker is achieved by switching the electromotor to high speed after detaching the paddle or mixing arm 104. When the mixing arm 104 is detached from the rotor shaft 112, air vents out from the vessel, reducing oxygen and preserving food for extended periods.

FIG. 2 illustrates a top view of pressure cooker lid in accordance with one embodiment of the present invention. Referring to FIG. 2, the lid 106 has a pair of ergonomic handles 114 disposed thereon. The handles 114 are used for removing and placing the lid 106 on the pressure cooker vessel. A pair of spring-loaded clamps 116 secure the lid 106 to prevent tilting of the lid 106 and the cooker during operation thereof. A steam turbine 118 is disposed in the pressure cooker for providing steam for cooking food items inside the cooker.

One or more sensors such as pressure sensor 120a and atmospheric sensor 120b are disposed in the lid 106 and are used for measuring both atmospheric and internal pressure of the pressure cooker. The sensors 120a, 120b form the part of Control Area Network (CAN) control module 121 of the system 100 as described later in the disclosure. Based on the measurements of the sensors 120a, 120b, a solenoid 122 and a spindle shaft 124 are adjusted to partially close and open the vent port 110.

During the initial cooking phase, the control module sets the rotor shaft 112 to a low constant speed of, for example, one rotation every two seconds. The low-speed rotation causes gentle stirring which provides uniform mixing of ingredients, prevents sticking to the body or drum 107, and maintains even heat distribution. In the second stage, once the cooking is complete, and the mixing paddle or arm 104 is removed, the system transitions to the vacuum-scaling phase. Speed of the rotor shaft increases to at least 700 RPM to extract air from the drum via the vent port, creating a vacuum inside the vessel. The high-speed operation helps in reducing oxygen levels, thereby preventing oxidation and extending the freshness of the food.

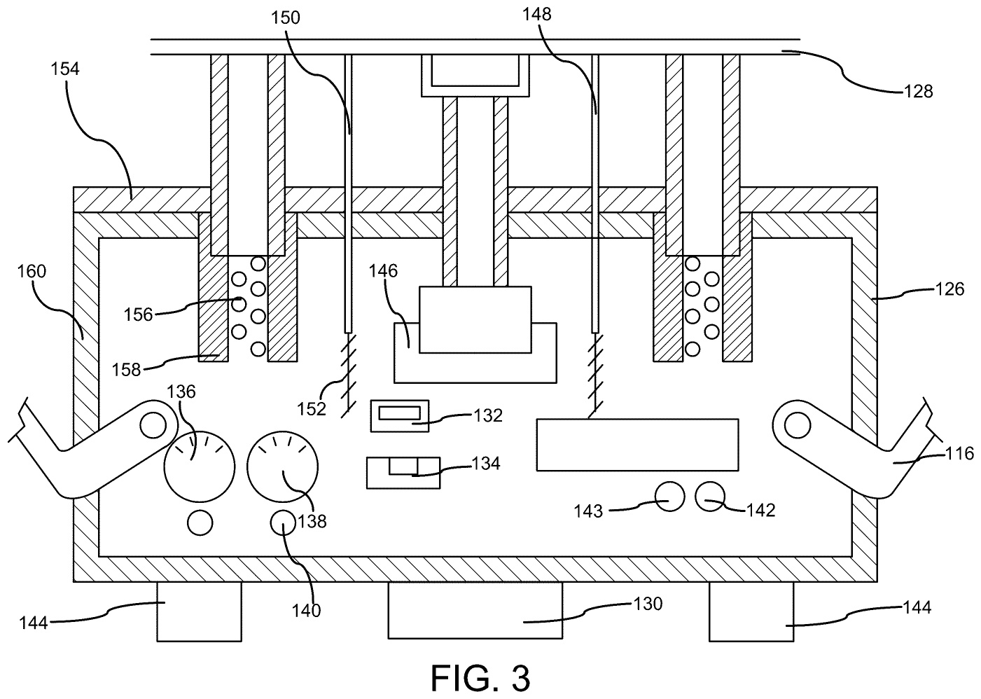

FIG. 3 illustrates a planar view of one embodiment of the heater stove used in the system of the present invention in accordance with the disclosed structure. Referring to FIG. 3, the pressure cooker body 107 includes the heater stove 126 equipped with a weighing scale in the base of the heater stove 126. The heater stove 126 has a heating coil 128 which is used for providing heat to the cooker body or drum 107. A display screen 130 is disposed in the heater stove 126 for displaying temperature and pressure inside the cooker body or drum 107 while enabling a user to customize the configuration of the system 100.

The stove 126 includes a USB port 132 and a memory card port 134 for enabling a user storing and using cooking recipes, cooking settings, processes, and more. A temperature control knob 136 is used for controlling heat applied by a heater coil used in the system 100. An inner vessel pressure adjuster 138 is configured to adjust the inner pressure of the body or drum 107 for providing consistent and uniform heating and cooking.

A locking button 140 is disposed in the stove 126 for locking the cooker body or drum 107 in position and securing the cooker. A weighing scale reset button 142 is configured to reset the embedded weighing scale of the stove 126 to ‘zero-out’ the scale for measurement (i.e., weighing) of subsequently added ingredients. A weighing scale power button 143 is configured to activate and deactivate the weighing scale and may be functional with heater coil of the stove 126 is in an off or inactive state. For providing a stable support to the stove 126, one or more supporting legs 144 are disposed in the stove and are used for providing a secure placement to the stove 126 on any surface.

As the stove 126 has electrical components, the stove 126 uses a strain gauge load cell 146 for accurate weight measurement and is bonded to a heater coil mounting support 148. Preferably, the heater stove 126 supports a maximum of 25 pounds and can weigh ingredients separately. The heater stove 126 includes one or more electrical wires 150 coupled to electric pins 152. For safety and protection, the heater stove 126 includes a ceramic insulator 154 between the heater coil 128 and the weighing scale to prevent heat damage. For providing a flexibility and space (i.e., speed) between the components of the heater stove 126, a plurality of springs 156 are accommodated inside a spring housing 158.

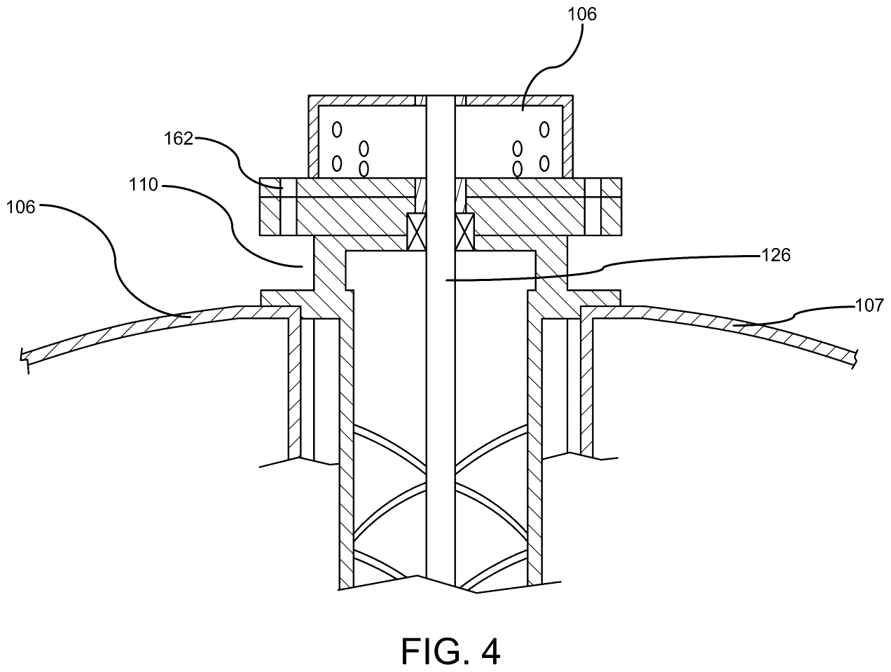

Referring to FIG. 4, the electromotor 102 is mounted on top of the steam turbine 118. A pressure cooker lead 160 houses a steam generator which functions along with the steam turbine 118 for generating steam and can be integrated in the cooker body or drum 107. A lower flange 162 of generator has the vent port 110 which is controlled by the spindle shaft 124.

In use, the ingredients are placed inside the pressure cooker and the mixing arm is attached. The CAN unit maintains optimal pressure and temperature and the mixing arm stirs ingredients to prevent sticking and achieve a uniform texture. The CAN detects changes in the electrical current drawn by the electromotor to assess ingredient viscosity. When the current draw increases by 15%-25%, the current indicates sufficient thickening, and the cooking process transitions to the final stirring phase. The mixing arm is removed, and the electromotor accelerates to create a vacuum, preserving the food by eliminating oxygen. The CAN may record the entire process for future use and consistency.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “automated (i.e., autonomous) multifunctional pressure cooker system”, “advanced cooking apparatus with dual-speed electromotor,”, “automated (i.e., autonomous) pressure cooker system”, “and “system” are interchangeable and refer to the advanced cooking apparatus with dual-speed electromotor 100 of the present invention.

Notwithstanding the forgoing, the advanced cooking apparatus with dual-speed electromotor 100 of the present invention can be of any suitable size and configuration as is known in the art without affecting the overall concept of the invention, provided that it accomplishes the above stated objectives. One of ordinary skill in the art will appreciate that the advanced cooking apparatus with dual-speed electromotor 100 as shown in the FIGS. are for illustrative purposes only, and that many other sizes and shapes of the advanced cooking apparatus with dual-speed electromotor 100 are well within the scope of the present disclosure. Although the dimensions of the advanced cooking apparatus with dual-speed electromotor 100 are important design parameters for user convenience, the advanced cooking apparatus with dual-speed electromotor 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An autonomous pressure cooker system comprising:
a pressure cooker having a cooker body and a cooker lid;
an electromotor;
a selectively removable mixing arm; and
a rotor shaft;
wherein said cooker lid having a safety valve to control a pressure inside said pressure cooker;
wherein said cooker lid having a vent port selectively openable and closable for controlling release of steam from said pressure cooker;
wherein said electromotor rotates said rotor shaft at a first slower speed when said mixing arm is attached to said rotor shaft for uniform stirring of ingredients in said pressure cooker; and
further wherein said electromotor rotates said rotor shaft at a second faster speed when said mixing arm is not attached to said rotor shaft for extracting air from said pressure cooker to create a vacuum within said pressure cooker.

2. The autonomous pressure cooker system of claim 1, wherein said first slower speed rotates said rotor shaft from 10 RPM to 30 RPM when said mixing arm is attached to said rotor shaft.

3. The autonomous pressure cooker system of claim 2, wherein said second faster speed rotates said rotor shaft at least 700 RPM when said mixing arm is not attached to said rotor shaft.

4. The autonomous pressure cooker system of claim 3, wherein said first slower speed is during a first cooking phase of said pressure cooker.

5. The autonomous pressure cooker system of claim 4, wherein said second faster speed is during a second vacuum-sealing phase of said pressure cooker.

6. The autonomous pressure cooker system of claim 5 further comprising a steam turbine, wherein said steam turbine disposed inside said cooker body for providing steam for said first cooking phase inside said pressure cooker.

7. The autonomous pressure cooker system of claim 6, wherein said cooker lid having a pressure sensor and an atmospheric sensor for measuring both internal pressure and atmospheric pressure of said pressure cooker.

8. The autonomous pressure cooker system of claim 6, wherein said cooker lid having a solenoid and a spindle shaft for adjusting an opening of said vent port based on measurements of said pressure sensor and said atmospheric sensor.

9. The autonomous pressure cooker system of claim 1, wherein said cooker body having a heating coil including a weighing scale in a base of said cooker body, and further wherein said weighing scale measures a weight of the ingredients in said cooker body.

10. The autonomous pressure cooker system of claim 9, wherein said weighing scale having a reset button to ‘zero-out’ said weighing scale to measure a weight of subsequently added ingredients.

11. An autonomous pressure cooker system comprising:
a pressure cooker having a cooker body and a cooker lid;
an electromotor;
a selectively removable mixing arm; and
a rotor shaft;
wherein said cooker lid having a safety valve to control a pressure inside said pressure cooker;
wherein said cooker lid having a vent port selectively openable and closable for controlling release of steam from said pressure cooker;
wherein said electromotor rotates said rotor shaft at a first slower speed when said mixing arm is attached to said rotor shaft for uniform stirring of ingredients in said pressure cooker;
wherein said electromotor rotates said rotor shaft at a second faster speed when said mixing arm is not attached to said rotor shaft for extracting air from said pressure cooker to create a vacuum within said pressure cooker;
wherein said first slower speed is during a first cooking phase of said pressure cooker;
wherein said second faster speed is during a second vacuum-sealing phase of said pressure cooker;
wherein said cooker body having a heating coil including a weighing scale in a base of said cooker body; and
further wherein said weighing scale measures a weight of the ingredients in said cooker body.

12. The autonomous pressure cooker system of claim 11, wherein said first slower speed rotates said rotor shaft from 10 RPM to 30 RPM when said mixing arm is attached to said rotor shaft.

13. The autonomous pressure cooker system of claim 12, wherein said second faster speed rotates said rotor shaft at least 700 RPM when said mixing arm is not attached to said rotor shaft.

14. The autonomous pressure cooker system of claim 11 further comprising a steam turbine, wherein said steam turbine disposed inside said cooker body for providing steam for said first cooking phase inside said pressure cooker.

15. The autonomous pressure cooker system of claim 14, wherein said cooker lid having a pressure sensor and an atmospheric sensor for measuring both internal pressure and atmospheric pressure of said pressure cooker.

16. The autonomous pressure cooker system of claim 15, wherein said cooker lid having a solenoid and a spindle shaft for adjusting an opening of said vent port based on measurements of said pressure sensor and said atmospheric sensor.

17. The autonomous pressure cooker system of claim 11, wherein said weighing scale having a reset button to ‘zero-out’ said weighing scale to measure a weight of subsequently added ingredients.

18. An autonomous pressure cooker system comprising:
a pressure cooker having a cooker body and a cooker lid;
an electromotor;
a selectively removable mixing arm;
a rotor shaft; and
an inner vessel pressure adjuster;
wherein said cooker lid having a safety valve to control a pressure inside said pressure cooker;
wherein said cooker lid having a vent port selectively openable and closable for controlling release of steam from said pressure cooker;
wherein said electromotor rotates said rotor shaft at a first slower speed when said mixing arm is attached to said rotor shaft for uniform stirring of ingredients in said pressure cooker;
wherein said electromotor rotates said rotor shaft at a second faster speed when said mixing arm is not attached to said rotor shaft for extracting air from said pressure cooker to create a vacuum within said pressure cooker;
wherein said first slower speed is during a first cooking phase of said pressure cooker;
wherein said second faster speed is during a second vacuum-sealing phase of said pressure cooker;
wherein said cooker lid having a pressure sensor and an atmospheric sensor for measuring both internal pressure and atmospheric pressure of said pressure cooker;
wherein said cooker lid having a solenoid and a spindle shaft for adjusting an opening of said vent port based on measurements of said pressure sensor and said atmospheric sensor; and
further wherein said inner vessel pressure adjuster autonomously adjusts the internal pressure of said cooker body for providing uniform heating.

19. The autonomous pressure cooker system of claim 18 further comprising a steam turbine, wherein said steam turbine disposed inside said cooker body for providing steam for said first cooking phase inside said pressure cooker.

20. The autonomous pressure cooker system of claim 19, wherein said cooker body having a heating coil including a weighing scale in a base of said cooker body, wherein said weighing scale measures a weight of the ingredients in said cooker body, and further wherein said weighing scale having a reset button to ‘zero-out’ said weighing scale to measure a weight of subsequently added ingredients.
